(19) United States
(12) Patent Application Publication
(10) Pub. No.: US 2013/0107047 A1
(43) Pub. Date: May 2, 2013

(54) Multifunction Vehicle Display Monitor With Video Capability

(71) Applicants: Lance R. Sherlock, Asbury, IA (US); Richard Pugh, Dubuque, IA (US); Ryland H. Eichhorst, Peosta, IA (US)

(72) Inventors: Lance R. Sherlock, Asbury, IA (US); Richard Pugh, Dubuque, IA (US); Ryland H. Eichhorst, Peosta, IA (US)

(21) Appl. No.: 13/285,475

(22) Filed: Oct. 31, 2011

(51) Int. Cl. H04N 7/18

(52) U.S. Cl. 348/148; 348/E07.085

(57) ABSTRACT

A multifunction monitor display system capable of showing vital vehicle information, such as available fuel, engine oil temperature and vehicle power mode in a first format on a primary display area of a display screen in a first mode and showing video images from a video camera in the primary display area and the vital vehicle information in a second format on a secondary display area of the display screen in a second mode. The secondary display area is an area that may be separate and discrete from, as well as smaller than, the primary display area

### FIELD OF THE INVENTION

The invention generally relates to electronic vehicular display monitors. More specifically, it relates to vehicular display monitors with the capability of displaying their information and functions in more than one language.

### BACKGROUND OF THE INVENTION

Electronic display monitors have become widely used to display vital vehicle information in construction and other heavy duty equipment. Similarly, electronic video cameras are becoming somewhat commonplace features for such vehicles. Electronic video cameras are generally used to provide vehicle operators with important views that they would not normally have and usually require electronic display monitors to display the images they gather. Thus, the electronic video cameras may be used in conjunction with a monitor in a cab of the vehicle.

Conventional display monitors used for displaying image data from video cameras usually come in one of the following two forms: (1) a dedicated video monitor mounted in the cab; and (2) an electronic display monitor already in use to display vital vehicle information. A challenge with form (1) is that it-may occupy too much cab space in requiring the cab to have two monitors as cab space usually comes at a premium. Form (2) commonly results in a difficulty or an inability to view the vital vehicle information due to an overwhelming presence of video images on the display screen as the images from the camera may either be superimposed on, or temporarily replace the vital vehicle information.

### SUMMARY OF THE INVENTION

Disclosed herein is a display system for a work vehicle which includes a multifunction display-monitor capable of displaying vital vehicle information and a controller in communication with the multifunction monitor. The display system may have the following two modes: (1) the multifunction monitor displays the vital vehicle information in a first format; and (2) the multifunction monitor displays vital vehicle information in a second format. The first format for vital vehicle information may be in the form of detailed graphics and/or text occupying a first area of a display the second format may be in the form of summary graphics and/or text in a second area of the screen which is smaller than the first area. The second area of the display is at least partially exclusive of, i.e., separate from; the first area of the display. The second format may be used when the multifunction monitor is displaying images from, for example, a video camera in the first area of the display. This display system virtually eliminates the limitations of the two conventional forms mentioned above.

### BRIEF DESCRIPTION OF THE DRAWINGS

FIG. 1 illustrates an exemplary embodiment of a vehicle on which the invention may be used;

FIG. 2 illustrates an exemplary diagram of the multifunction monitor display system;

FIG. 3 illustrates the Multifunction display monitor of FIG. 2 displaying available fuel, engine oil temperature and vehicle power mode in a primary or larger area of the display;

FIG. 4 illustrates the multifunction display monitor of FIG. 3 displaying images from a first camera in the larger area of the screen and the vital vehicle information in a smaller area of the display screen;

FIG. 5 illustrates the multifunction monitor of FIG. 3 displaying images from a second camera in the larger area of the screen and the vital vehicle information in a smaller area of the display screen; and

FIG. 6 illustrates an exemplary embodiment of a flowchart for the display system of FIG. 2.

### DESCRIPTION OF THE PREFERRED EMBODIMENT

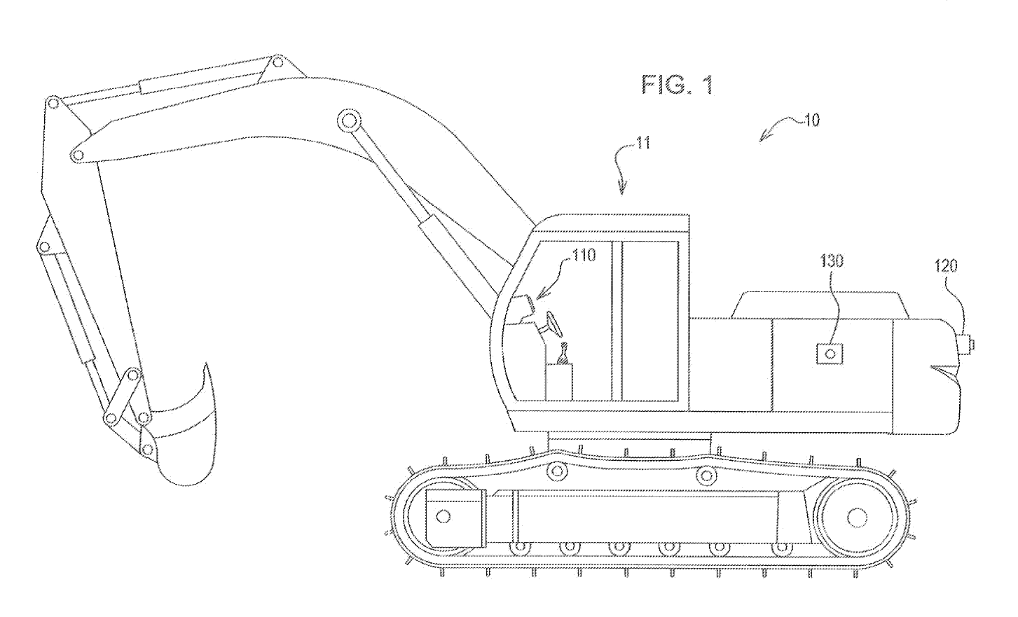

FIG. 1 illustrates an exemplary embodiment of a vehicle in which the invention may be used. In this particular case the vehicle is a work vehicle 10 classed as an excavator having a cab 11, a frame 12, an undercarriage 13 and a linkage 14. As illustrated, an electronic display monitor 110 capable of displaying video may be disposed in the cab 11 and two (2) cameras, i.e., a first camera 120 and a second camera 130, may be attached to the frame 12, all of which form at least a part of a multifunction display system 100.

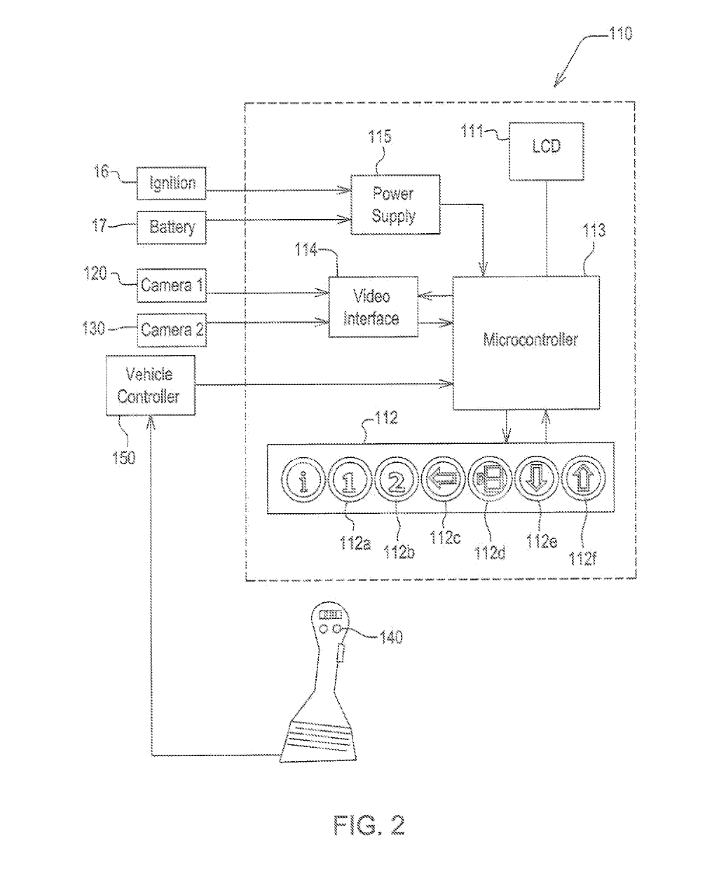

FIG. 2 illustrates an exemplary diagram of the multifunction display system 100 which may include: a conventional ignition 16; a conventional battery 17; the multifunction display monitor 110; the first video camera 120; the second video camera 130; a joystick camera button 140 mounted on a joystick 15; and a vehicle controller 150. As illustrated: the vehicle controller 150 may receive signals from the joystick camera, button 140; and may send and receive signals to and from the display monitor 110. As illustrated, the display monitor 110 may receive video signals from the first and second video cameras 120, 130. As indicated by the illustration, the first and second video cameras 120, 130 and the vehicle controller 150 may be powered and sending signals to the multifunction display monitor 110 as long as the ignition 16 for the vehicle 10 is on.

As illustrated, the multifunction display monitor 110 may include: a liquid crystal display 111; an array of buttons 112 conventionally operated) which may include a first camera button 112a and a second camera button 112b; a microcontroller 113; a video interface 114; and a power supply 115 connected with the ignition 16. As illustrated, the microcontroller 113 is in communication, with the video interface 114, the vehicle controller 150 and the array of buttons 112 and operably connected to the display 111,

As illustrated, the video interface 114 may be configured to receive video signals from each of the first and the second cameras 120, 130 and may include a conventional internal switching arrangement (not illustrated) which, upon instructions, via signals from the microcontroller 113, will either send a video signal from one of the first and second cameras 120, 130 to the microcontroller 113 or send no signal to the microcontroller 113. The microcontroller 113 operates in accordance with software contained in a memory device which may be a USB memory stick (not shown). The software is loaded when the multifunction display monitor 110 is powered up, i.e., when the ignition 16 is turned on.

The multifunction display monitor 110 may be configured, via monitor software, to display primary information in a primary portion of the display screen 111′, i.e., a display area that is larger than any other display area on the display screen 111; and secondary information in a secondary portion of the display screen 111″, i.e. in an area of the display screen that is smaller than that of the primary portion of the, screen 111′. The primary portion of the display screen 111′ may be separate and distinct from the secondary portion of the display screen 111″. Primary information may be information that is of primary importance, i.e., it may be deemed to be the most relevant information for the operator to monitor during a particular operation such as, for example, live video of a rear view as the vehicle travels in a reverse direction. Secondary information may be information that is important for the operator to monitor but not of primary importance during a particular operation such as, for example, engine rpm during normal vehicle operations.

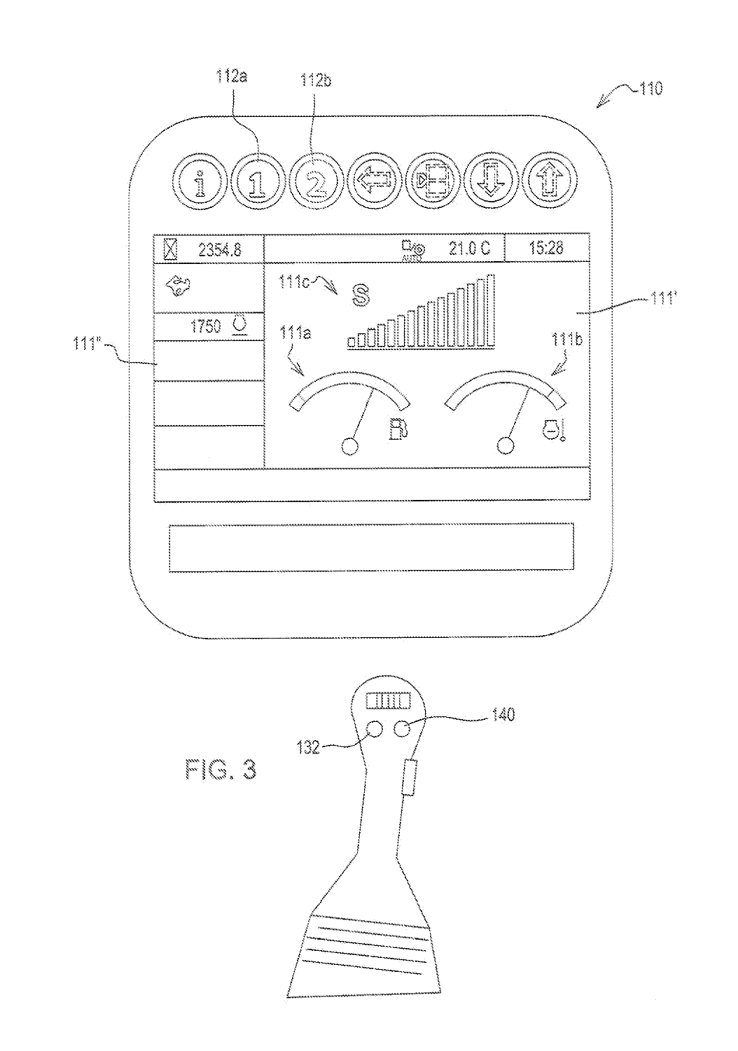

Primary information may default to “vital vehicle information” such as available fuel, engine oil temperature and vehicle power-mode, as illustrated in FIG. 3, on startup of the vehicle 10 as this information may be of primary importance when the vehicle is merely idling or in locomotion. As such, this information may be set-to display as exemplary graphical images 111a, 111b and 111c, respectively, as illustrated in FIG. 3a while other important information such as for example, hours of operation and engine rpm may default to secondary information and be set to display as smaller summary images such as, for example, 111d and 111e respectively (see FIG. 3a). Naturally, primary and secondary information may include whatever information is deemed to fit those categories at any given time. Thus, in a different configuration, engine rpm may form a part of the primary information.

In this exemplary embodiment, the microcontroller 113 may be configured, via software, to populate the primary display area 111′ using video signals from the first video camera 120 (see FIG. 3b) if the first camera button 112a is operated while the multifunction display system 100 is powered, or if the joystick camera button 140 is operated while the microcontroller 113 is populating the primary portion of the display screen 111′ with vital vehicle information. Note that the number “1” appears under the video image indicating that the video is from the first camera 120.

The microcontroller 113 may also be configured to populate the primary display area 111′ using video signals from the second camera 130 if the second camera button is operated while the multifunction display system 100 is powered or if the joystick camera button 140 is operated while the microcontroller 113 is populating the liquid crystal display 111 using video signals from the first camera 120. Note that the number “2” appears under the video image indicating that the video is from the second camera 130 (see FIG. 3c).

The microcontroller 113 may also be configured to populate the primary display area 111′ with vital vehicle information, as shown in FIG. 3a, from the vehicle controller 150 by default when the multifunction display system 100 is initially powered via the ignition 16 or when the joystick camera button is operated while the microcontroller 113 is populating the primary display area 111′ using video signals from the second camera 130.

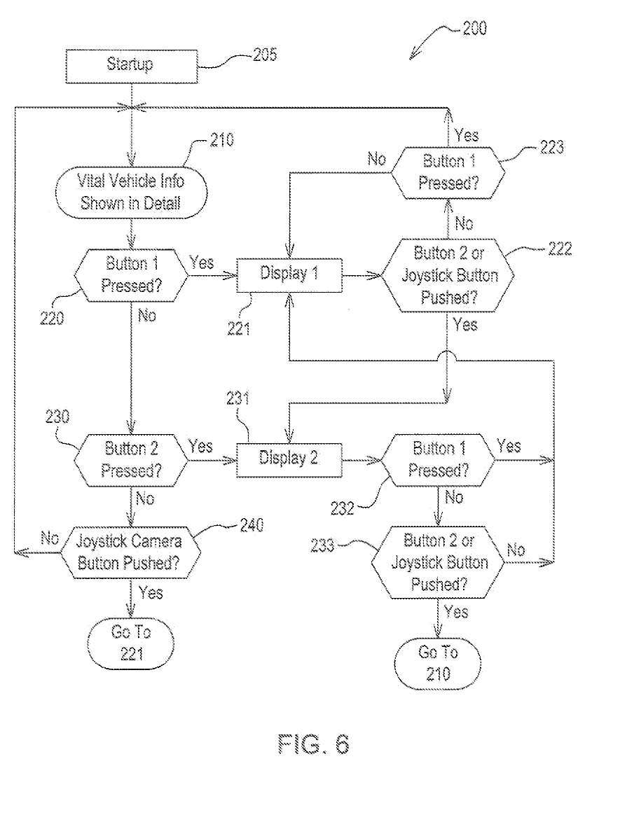

As illustrated in the flowchart 200 of FIG. 6, immediately after startup, i.e., after the ignition 16 is on at step 205, the multifunction monitor 110 may, at step 210, display the vital vehicle information (mentioned above, i.e., 111a, 111b and 111c) in detail in the primary display area 111′ while displaying the secondary information, if any, in the smaller secondary display area 111″ as illustrated in FIG. 3. The secondary information may, in this exemplary embodiment, include hours of operation and engine rpm (see 111d and 111e, respectively). If neither the first camera button 112a nor the second camera button 112b is operated at step 220 or 230, respectively, and if the multifunction display monitor 110 does not receive a signal from the vehicle controller 150, which the vehicle controller 150 would generate on operation of the joystick camera button 140 at step 240, the microcontroller 110 continues to populate the primary display area 111′ with vital vehicle information and the secondary display area 111″ With secondary information.

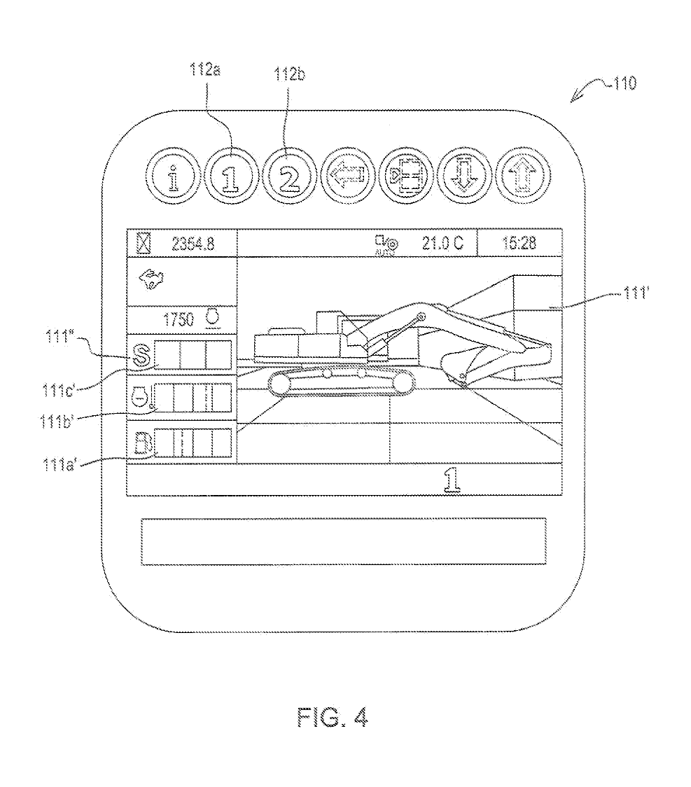

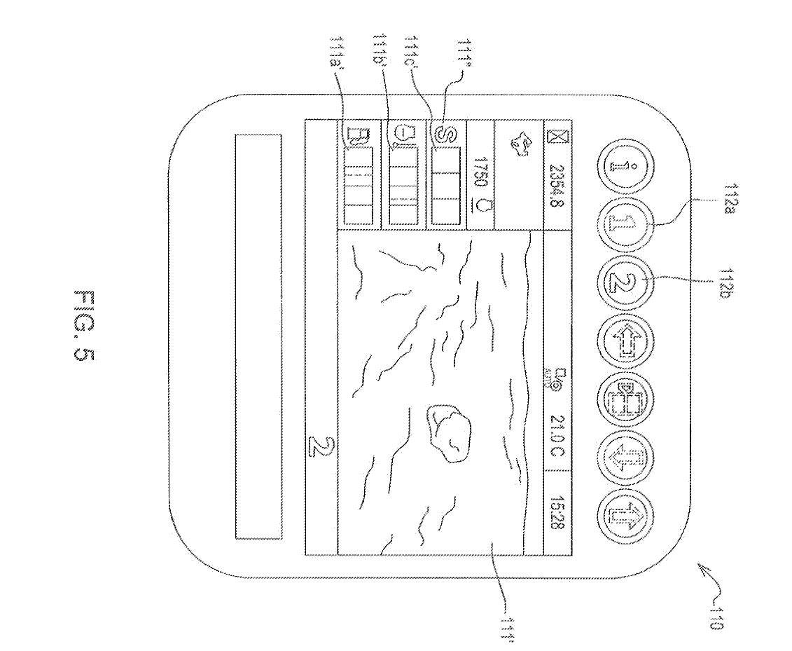

As illustrated in FIG. 6, if, after startup at step 205, the first camera button 112a is operated at step 220, the microcontroller 113 may configure the video interface 114 to deliver video signals from the first camera 120 and populate the primary display area 111′ using video signals received from the first camera 120 as primary information and populate the secondary display area with vital vehicle information received from the vehicle controller 150 as secondary information instead of, or in addition to, the secondary information already displayed at step 221 (see FIG. 3). Further, as illustrated in FIGS. 4 and 5, the vital vehicle information may now be displayed in a form that is abbreviated or summary yet easily read, such as, for example, the simple bar graphs 111a′, 111b′ and 111c′.

If neither the joystick camera button 140 nor the second camera button 112b is operated at step 222, the microcontroller 113 determines if the first camera button 112b has once again, been operated and if not, the microcontroller 113 continues to populate the primary display area 111′ using the video signal from the first camera 120. If the first camera button 112a has, once again, been or is operated, the multifunction display monitor 110 may cease to display the video signals from the first camera 120 and, once again, display vital vehicle information as primary information, i.e., the microcontroller 113 may populate the primary display area 111′ with vital vehicle information and discontinue populating it with video data from the first camera 120. However, if the joystick camera button 140 or the second button 112b is operated at step 222, the microcontroller 113 will cease using video data from the first camera 120 as primary information, and begin to use video data from the second camera as primary information at step 231, i.e., the multifunction display monitor 110 will display video data from the second camera 130 in the primary display area (see FIG. 4). If, at any time, the first camera button 112a is operated while the multifunction display monitor 110 is displaying video data from the second camera 130, such as at step 232, the multifunction display monitor 110 will display video from the first camera 120 as primary information as in step 221. However, if the second camera button 114 or the joystick camera button 140 is operated as at step 233, i.e., while the multifunction monitor 110 is displaying video data from the second camera 130, the multifunction display monitor 110 may return to step 210 and display Vital vehicle information as primary information.

If the joystick camera button 140 is operated while the multifunction display monitor 110 is displaying vital vehicle information as primary information, i.e., displaying vital vehicle information in the primary display area 111′, as at step 240, the microcontroller 113 may cease to populate the primary display area 111′ with vital vehicle information and, instead, move to step 221 to populate the primary display area 111′ using video data from the first camera 120.

The multifunction display system 100 shuts down when the ignition 16 is turned of or when it is no longer receiving power from the power supply 115

Having described the preferred embodiment, it will become apparent that various modifications can be made without departing from the scope of the invention as defined in the accompanying claims.

The invention claimed is:

1. A display system for a work vehicle, comprising:
at least one video camera;
a vehicle controller; and
a multifunction monitor having a display screen and in communication with the Vehicle controller and the at least one video camera, the multifunction monitor having a plurality of modes including a first mode and a second mode, the vehicle controller capable of communicating vehicle information to the Multifunction monitor and sending control signals to the multifunction monitor, the at least one video camera capable of transmitting signals for video images to the multifunction monitor, the multifunction monitor capable of displaying the video images in a first area of the display screen and the vehicle information in a second area of the display screen in the first mode, the multifunction monitor capable of displaying the vehicle information in the first area and ceasing to display the video images in the second mode.

2. The display system of claim 1, wherein the first area of the display screen is larger than the second area of the display screen.

3. The display system of claim 2, wherein the second area of the display screen is separate and distinct from the first area of the display screen.

4. The display system of claim 1, further including a joystick camera button forming a part of a joystick and in communication with the vehicle controller, the joystick capable of sending signals to the vehicle controller upon operation of the joystick camera button.

5. The display system of claim 4, wherein operation of the joystick camera button sends a signal to the vehicle controller which causes the vehicle controller to generate and transmit a control signal to the multifunction monitor instructing the multifunction monitor to switch from one of the first and second modes to another of the first and second modes.

6. The display system of claim 1, wherein the multifunction monitor displays the vehicle information in a first format in the first Mode and displays it in a second format in the second mode.

7. The display system of claim 1, where in the at least one video camera comprises a first video camera and a second video camera.

8. A display system for a work vehicle, comprising:
at least one video camera;
a vehicle controller capable of transmitting vehicle information;
a multifunction monitor having a video controller in communication with the at least one video camera and capable of transmitting video images, a display screen, a microcontroller operably connected to the video controller and capable of causing the display Screen to display at least one of the vehicle information from the vehicle controller and the video images from the video controller, and at least one button operably connected to the microcontroller, the microcontroller having a plurality of modes including a first mode in which it causes the vehicle information to be displayed in a first area of the display screen and a second mode in which it causes the vehicle information to be displayed in a second area of the display screen separate and distinct from the first area of the display screen and the video images to be displayed in the first area of the display screen.

9. The display system of claim 6, wherein the monitor includes at least one switch operably connected to the microcontroller and corresponding to the at least one camera, the microcontroller switching from one of the plurality of modes to another of the plurality of modes upon operation of the at least one switch.

10. The display system of claim 8, Wherein the at least one switch comprises at least one button.

11. The display system of claim 9, further including a joystick camera button forming a part of a joystick in communication with the vehicle controller.

12. The display system of claim 10, wherein the vehicle controller directs the multifunction monitor to switch from the one of the plurality of modes to the other of the plurality of modes upon operation of the joystick camera button.
